(19) United States
(12) Patent Application Publication
(10) Pub. No.: US 2017/0228944 A1
(43) Pub. Date: Aug. 10, 2017

(54) METHOD FOR BILLING OF A PARKING FEE

(71) Applicant: Triple Domain Vision Co., Ltd., Zhubei City (TW)

(72) Inventors: Kung-Ming LAN, Zhubei City (TW); Wen-Hao WANG, Zhubei City (TW); Ching-Tien LIN, Zhubei City (TW)

(21) Appl. No.: 15/245,077

(22) Filed: Aug. 23, 2016

(30) Foreign Application Priority Data
Feb. 4, 2016 (TW) 105103699

(51) Int. Cl. G07B 15/02; G06K 9/32

(52) U.S. Cl. CPC G07B 15/02; G06K 9/325

(57) ABSTRACT

A method for billing of a parking fee includes the steps of: when it is determined that neither license plate identifier data nor time data is stored in a storage unit, that no target is contained in a current image, and that a license plate identifier is recognized in the current image, storing time at which the current image is captured and the license plate identifier in the storage unit to respectively serve as the time data and the license plate identifier data; and when it is determined that the license plate identifier data and the time data are stored, and that the license plate identifier is recognized, calculating a parking fee of the vehicle according to a parking rate, the time data, and the time at which the current image is captured.

### CROSS-REFERENCE TO RELATED APPLICATION

This application claims priority of Taiwanese Patent Application No. 105103699, filed on Feb. 4, 2016.

### FIELD

The disclosure relates to a method for billing of a parking fee, and more particularly to a method for billing of a parking fee for parking at a parking space.

### BACKGROUND

A conventional method for billing of a parking fee is implemented by manpower. A parking fee collector monitors parking spaces, manually photographs vehicles parked in the parking spaces, records license plate identifiers and parking times thereof, and provides billing notices, so that users of the parking spaces can pay the bills accordingly.

By the conventional method mentioned above, with the parking fee collector having to regularly monitor each parking space so as to record the license plate identifier of every newly arrived vehicle or update the parking durations of existing vehicles previously recorded, the parking fee collector may be unable to carry out his duty of parking fee billing if his area of responsibility is too large. As a result, to achieve relatively accurate parking fee billing for each parking space, more manpower may be needed such that each parking space can be monitored regularly. Consequently, labor cost is increased. Moreover, the conventional method may have a problem of undercharging due to human error, such as unclear photographs taken on a rainy day, incomplete updating of the parking durations, and incorrect recording of the license plate identifiers.

### SUMMARY

Therefore, an object of the disclosure is to provide a method for billing of a parking fee that can alleviate at least one of the drawbacks of the prior art.

According to a first aspect of the disclosure, the method for billing of a parking fee is to be implemented by a system which includes an image capturing unit capturing continuously a sequence of images of a parking space, a storage unit storing data associated with use of the parking space, and a processing unit electrically connected to the image capturing unit and the storage unit. The method includes the steps of:

a) determining whether any license plate identifier data and time data is stored in the storage unit after obtaining a current image of the images captured by the image capturing unit, the images containing a license plate of a vehicle only as the vehicle is entering or leaving the parking space;

b) when it is determined in step a) that neither license plate identifier data nor time data is stored in the storage unit, determining whether a target associated with the parking space is contained in the current image, and determining whether a license plate identifier of the vehicle is recognized in the current image after performing image recognition on the current image;

c) storing time at which the current image is captured and the license plate identifier in the storage unit to respectively serve as the time data and the license plate identifier data when it is determined in step b) that no target is contained in the current image and that the license plate identifier is recognized in the current image;

d) determining whether the license plate identifier of the vehicle is recognized in the current image after performing image recognition on the current image when it is determined in step a) that the license plate identifier data and the time data is stored in the storage unit; and

e) calculating a parking fee of the vehicle according to a parking rate, the time data, and the time at which the current image is captured when it is determined in step d) that the license plate identifier is recognized in the current image.

According to a second aspect of the disclosure, the method for billing of a parking fee is to be implemented by a system which includes an image capturing unit capturing continuously a sequence of images of a parking space, a storage unit storing data associated with use of the parking space, and a processing unit electrically connected to the image capturing unit and the storage unit. The method includes the steps of:

A) determining whether any license plate identifier data and time data is stored in the storage unit after obtaining a current image of the images captured by the image capturing unit, the images containing a license plate of a vehicle only as the vehicle is entering or leaving the parking space;

B) when it is determined in step A) that neither license plate identifier data nor time data is stored in the storage unit, determining whether a target associated with the parking space is contained in the current image, and determining whether a license plate identifier of the vehicle is recognized in the current image after performing image recognition on the current image;

C) storing time at which the current image is captured and the license plate identifier in the storage unit to respectively serve as the time data and the license plate identifier data when it is determined in step B) that no target is contained in the current image and that the license plate identifier is recognized in the current image;

D) determining whether the target associated with the parking space is contained in the current image when it is determined in step A) that the license plate identifier data and the time data is stored in the storage unit; and

D) calculating a parking fee of the vehicle according to a parking rate, the time data, and the time at which the current image is captured when it is determined in step D) that the target associated with the parking space is contained in the current image.

### BRIEF DESCRIPTION OF THE DRAWINGS

Other features and advantages of the disclosure will become apparent in the following detailed description of the embodiment (s) with reference to the accompanying drawings, of which:

FIG. 1 is block diagram illustrating an embodiment of a system for billing of a parking fee according to the disclosure;

FIG. 2 is a schematic view illustrating exemplified arrangement of an image capturing unit of the system relative to a corresponding parking space;

FIG. 3 is a flow chart illustrating a first embodiment of the method for billing of a parking fee according to the disclosure; and

FIG. 4 is a flow chart illustrating a second embodiment of the method for billing of a parking fee according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

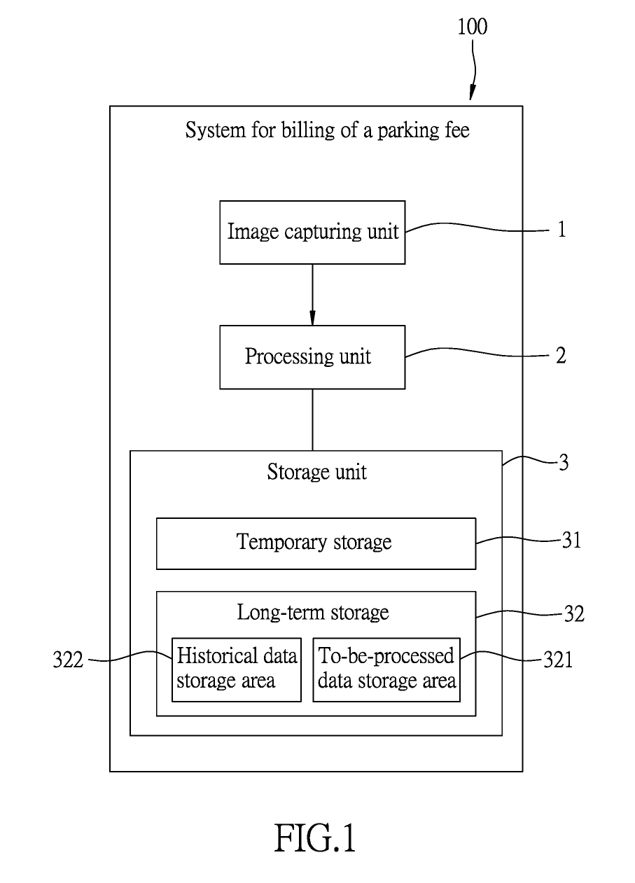

Referring to FIG. 1, a system 100 for billing of a parking fee is illustrated. The system 100 is utilized to implement a method for billing of a parking fee. The system 100 includes an image capturing unit 1, a storage unit 3, and a processing unit 2 electrically connected to the image capturing unit 1 and the storage unit 3.

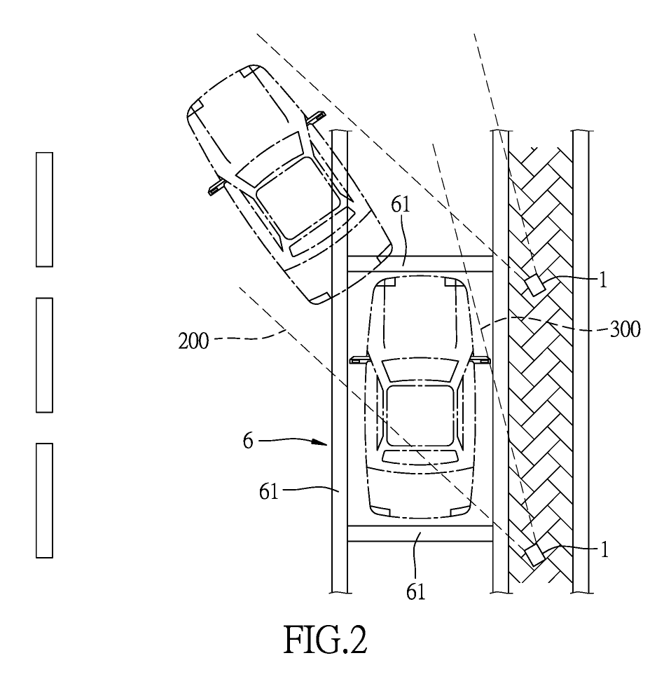

Referring to FIG. 2, the image capturing unit 1 is configured to capture continuously a sequence of images of a parking space 6. The parking space 6 is marked by, but not limited to, three road surface markings 61.

Referring back to FIG. 1, the storage unit 3 is electrically connected to the image capturing unit 1 and is configured to store data associated with use of the parking space 6. The storage unit 3 includes a temporary storage 31 and a long-term storage 32. The temporary storage 31 is configured to temporarily store every image captured by the image capturing unit 1. The long-term storage 32 includes a to-be-processed data storage area 321 and a historical data storage area 322. The to-be-processed data storage area 321 is configured to store license plate identifier data and time data associated with use of the parking space 6. The historical data storage area 322 is configured to store historical data associated with usage history of the parking space 6.

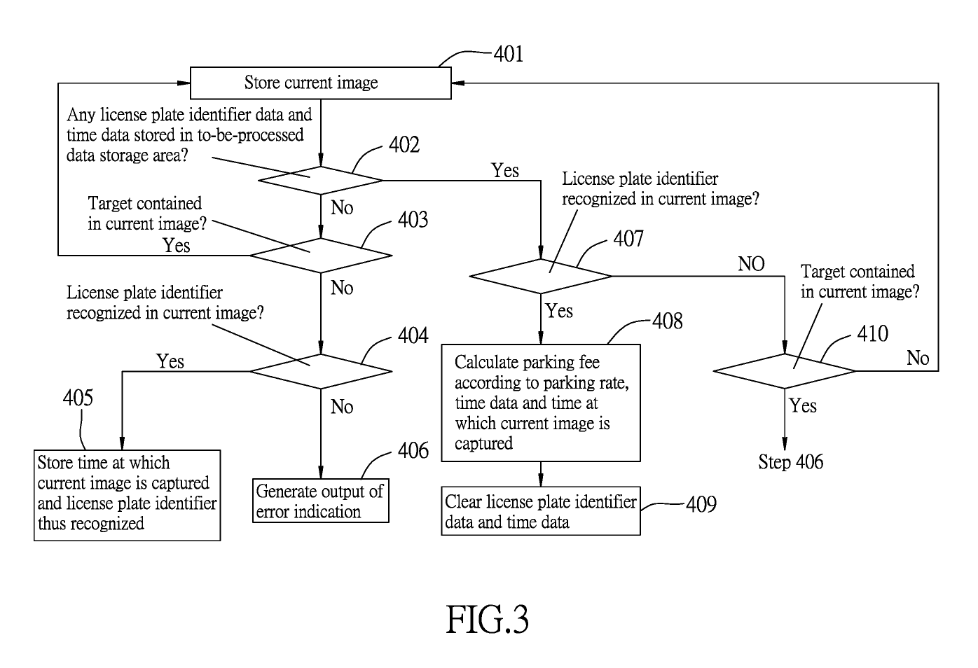

Referring to FIGS. 1 and 3, a first embodiment of the method for billing of a parking fee to be implemented by the system 100 is illustrated.

It is noted that in this embodiment, the image capturing unit 1 is disposed on a sidewalk and near a corner of the corresponding parking space 6 as shown in FIG. 2, such that the images captured by the image capturing unit 1 would contain a license plate of a vehicle only as the vehicle is entering or leaving the corresponding parking space 6, and would not contain the license plate of the vehicle when the vehicle is parked properly in the corresponding parking space 6.

The method has the following steps 401-410.

In step 401, after obtaining a current image of the images captured by the image capturing unit 1, the processing unit 2 stores the current image in the temporary storage 31.

In step 402, the processing unit 2 determines whether any license plate identifier data and time data is stored in the to-be-processed data storage area 321. When it is determined that neither license plate identifier data nor time data is stored in the to-be-processed data storage area 321, step 403 is executed. Otherwise, when it is determined that there are license plate identifier data and time data stored in the to-be-processed data storage area 321, step 407 is executed.

In step 403, the processing unit 2 performs image matching on the current image, and determines whether a target associated with the corresponding parking space 6, that is, a predetermined portion of the road surface markings 61 that mark the corresponding parking space 6, is contained in the current image according to a result of the image matching. When it is determined that no target is contained in the current image in step 403, which means that a vehicle is entering the corresponding parking space 6 and hides a portion of the road surface markings 61 from being captured in the current image, step 404 is executed. Otherwise, when it is determined that the target is contained in the current image, which means that the predetermined portion of the road surface markings 61 is not hidden, the flow goes back to step 401.

In this embodiment, the target is the portion of the road surface markings 61 that would be captured by the image capturing unit 1 when no vehicle is parked in the corresponding parking space 6. For example, as shown in FIG. 2, the target is the portion of the road surface markings 61 marking the corresponding parking space 6 and within a field of view of the image capturing unit 1 defined by a first dotted line 200 and a second dotted line 300.

In step 404, the processing unit 2 determines whether a license plate identifier of a vehicle is recognized in the current image after performing image recognition on the current image. When it is determined that the license plate identifier is recognized in the current image, step 405 is executed. Otherwise, when it is determined that no license plate identifier is recognized in the current image, step 406 is executed. It is noted that in this step, the processing unit 2 may determine first whether the current image contains any portion that corresponds to a template of a license plate. When it is determined that the current image contains the portion that corresponds to the template of a license plate, the processing unit 2 may then determine whether the license plate identifier of the vehicle is recognized in the current image by performing Optical Character Recognition (OCR) on the current image.

In step 405, the processing unit 2 stores time at which the current image is captured and the license plate identifier recognized in step 404 in the to-be-processed data storage area 321 to respectively serve as the time data and the license plate identifier data. Additionally, the processing unit 2 further stores in the historical data storage area 322 the current image that is stored in the temporary storage 31 in step 401, and at least one previous image of the images that is previously stored in the temporary storage 31 and that is captured by the image capturing unit 1 within a predetermined time period before the current image is captured. The images stored in the historical data storage area 322 serve as the historical data. For example, when the current image stored in the temporary storage 31 contains the vehicle entering the parking space 6 and the license plate identifier thereof, at least one previous image of the images stored in the temporary storage 31 would contain the portion of the road surface markings 61, indicating that no vehicle was parked in the parking space 6. Therefore, the current and previous images stored in the historical data storage area 322 may serve as evidence that the vehicle is parked in the parking space 6. In other embodiments, besides the above-mentioned images stored in the historical data storage area 322, the processing unit 2 further stores in the historical data storage area 322 at least one subsequent image of the images that is captured immediately subsequent to the current image obtained in step 401. The subsequent image may be utilized to serve as part of the evidence that the vehicle is parked in the parking space 6.

In step 406, when it is determined in step 404 that no license plate identifier of the vehicle is recognized in the current image, the processing unit 2 generates an output of error indication. For example, the output of error indication could be, but not limited to, one of a sound signal, a light signal, a text message and combinations thereof, which could be utilized to notify related personnel of the parking space 6 that an abnormal condition has occurred. In other embodiments, when the output of error indication is the text message, the processing unit 2 could transmit to a management terminal the output of error indication via a communication unit connected thereto.

In step 407, when it is determined in step 402 that the license plate identifier data and the time data are stored in the to-be-processed data storage area 321, the processing unit 2 determines whether the license plate identifier of the vehicle is recognized in the current image after performing image recognition on the current image. When it is determined that the license plate identifier is recognized in the current image in step 407, which means that the vehicle having the corresponding license plate identifier and previously parked in the parking space 6 is leaving the parking space 6, steps 408 and 409 are successively executed. Otherwise, when it is determined that no license plate identifier is recognized in the current image in step 407, which means that the vehicle corresponding to the license plate identifier data is still parked in the parking space 6, step 410 is executed.

In step 408, the processing unit 2 calculates a parking fee of the vehicle according to a parking rate, the time data stored in the to-be-processed data storage area 321, and the time at which the current image is captured. It is noted that in a normal condition, the license plate identifier recognized in the current image in step 407 should match the license plate identifier data stored in the to-be-processed data storage area 321. In this case, the time data stored in the to-be-processed data storage area 321 should indicate an instant in time at which the vehicle was entering the parking space 6, i.e. the start time of parking. The time at which the current image is captured should indicate the time at which the vehicle is leaving the parking space 6, i.e. the end time of parking. In addition, the processing unit 2 further stores in the historical data storage area 322 the time data and the license plate identifier data stored in the to-be-processed data storage 321, the time at which the current image is captured, the current image stored in the temporary storage 31 in step 401, and at least one previous image stored in the temporary storage 31 and captured by the image capturing unit 1 within a predetermined time period before the current image is captured. For example, when the current image contains the vehicle which corresponds to the license plate identifier data and which is leaving the parking space 6, at least one previous image stored in the temporary storage 31 should indicate that the vehicle was parked in the parking space 6. Therefore, the current and previous images stored in the historical data storage area 322 could serve as evidence that the vehicle has left the parking space 6. In other embodiments, aside from the current and previous images, the processing unit 2 further stores in the historical data storage area 322 at least one subsequent image of the images that is captured immediately subsequent to the current image obtained in step 401 to serve as part of the evidence that the vehicle has left the parking space 6.

Accordingly, for the same vehicle, during a period between the time instants of entering and leaving the parking space 6, the historical data storage area 322 stores the license plate identifier data of the vehicle parked, the time data corresponding to the start time of parking, a plurality of images as the evidence that the vehicle was entering the parking space 6, the time data corresponding to the end time of parking, and a plurality of images as the evidence that the vehicle was leaving the parking space 6. Therefore, the historical data storage area 322 stores necessary data related to parking of the vehicle which allows a user to check the information later on.

In step 409, the processing unit 2 clears the license plate identifier data and the time data stored in the to-be-processed data storage area 321.

In step 410, when determining in step 407 that no license plate identifier is recognized in the current image, the processing unit 2 determines whether the target is contained in the current image. When it is determined that the target is not contained in the current image, which means that the vehicle is still parked in the parking space 6, the flow goes back to step 401. Otherwise, when it is determined that the target is contained in the current image, which means that no vehicle is parked in the parking space 6, step 406 is executed.

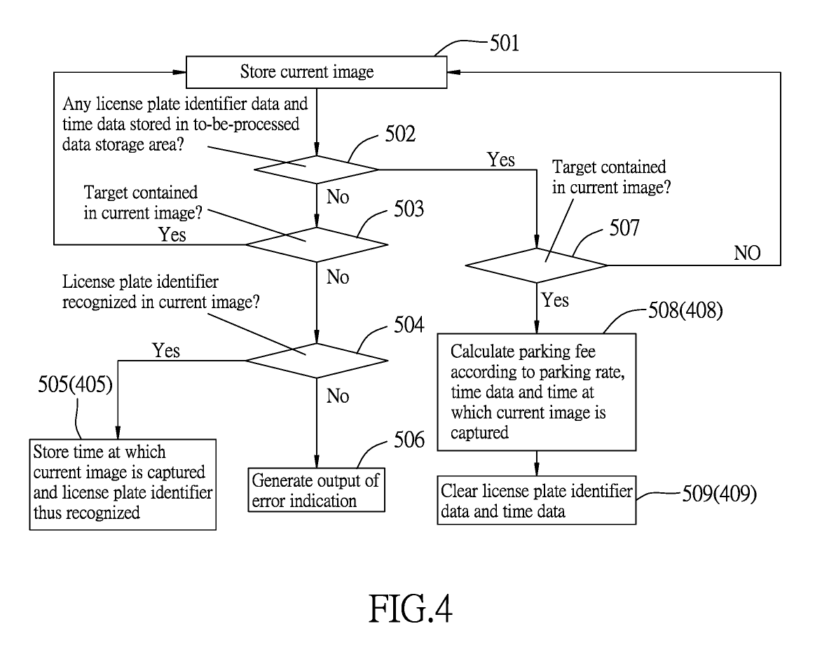

Referring to FIGS. 1 and 4, a second embodiment of the method for billing of a parking fee to be implemented by the system 100 is illustrated. The second embodiment includes steps 501-509, wherein steps 501-506 are respectively similar to steps 401-406 in the first embodiment as shown in FIG. 3.

In step 507, when it is determined in step 502 that the license plate identifier data and the time data are stored in the to-be-processed data storage area 321, the processing unit 2 determines whether the target associated with the parking space 6 is contained in the current image. It is noted that in this embodiment, when it is determined that the target is not contained in the current image in step 507, which means that the vehicle is still parked in the parking space 6, the flow goes back to step 501. Otherwise, when it is determined in step 507 that the target is contained in the current image, which means that the vehicle has left the parking space 6, steps 508 and 509 are successively executed.

Because operations of the processing unit 2 in steps 508 and 509 are respectively similar to those in steps 408 and 409 of the first embodiment, details of the same will be omitted herein.

To sum up, whenever an image captured by the image capturing unit 1 is obtained, the processing unit 2 executes determinations as to presence or absence of the license plate identifier data and the time data in the to-be-processed data storage area 321, presence or absence of the target in the current image, and identification of the license plate identifier, if contained in the current image. With the above approach, the method of this disclosure allows relatively precise recording of the license plate identifier and the start time of parking whenever any vehicle enters a parking space 6, and allows relatively precise calculation of the parking fee when the vehicle is no longer parked in the parking space 6. As a consequence, the issue of human error in the conventional method may be alleviated.

It is noted that the system. 100 may include multiple image capturing units 1 for capturing images of multiple parking spaces 6, as depicted in FIG. 2. One skilled in the art would appreciate that either a single processing unit 2 for processing images captured by all of the image capturing units 1 or multiple processing units 2 to each process images captured by one or more image capturing units 1 may be implemented in such case.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for billing of a parking fee, the method to be implemented by a system which includes an image capturing unit capturing continuously a sequence of images of a parking space, a storage unit storing data associated with use of the parking space, and a processing unit electrically connected to the image capturing unit and the storage unit, the method comprising the steps of:
a) determining whether any license plate identifier data and time data is stored in the storage unit after obtaining a current image of the images captured by the image capturing unit, the images containing a license plate of a vehicle only as the vehicle is entering or leaving the parking space;
b) when it is determined in step a) that neither license plate identifier data nor time data is stored in the storage unit, determining whether a target associated with the parking space is contained in the current image, and determining whether a license plate identifier of the vehicle is recognized in the current image after performing image recognition on the current image;
c) storing time at which the current image is captured and the license plate identifier in the storage unit to respectively serve as the time data and the license plate identifier data when it is determined in step b) that no target is contained in the current image and that the license plate identifier is recognized in the current image;
d) determining whether the license plate identifier of the vehicle is recognized in the current image after performing image recognition on the current image when it is determined in step a) that the license plate identifier data and the time data is stored in the storage unit; and
e) calculating a parking fee of the vehicle according to a parking rate, the time data, and the time at which the current image is captured when it is determined in step d) that the license plate identifier is recognized in the current image.

2. The method of claim 1, further comprising, subsequent to step b), the step of:
f) generating an output of error indication when it is determined in step b) that no target associated with the parking space is contained in the current image, and that no license plate identifier of the vehicle is recognized in the current image.

3. The method of claim 1, further comprising, subsequent to step e), the step of:
g) clearing the license plate identifier data and the time data stored in the storage unit.

4. The method of claim 1,
wherein step c) includes further storing in the storage unit the current image, and at least one previous image of the images captured by the image capturing unit within a predetermined time period before the current image is captured;
wherein step e) includes further storing in the storage unit the current image, and at least one previous image of the images captured by the image capturing unit within a predetermined time period before the current image is captured.

5. The method of claim 1, the parking space being marked by road surface markings, wherein in step b), the target associated with the parking space is a predetermined portion of the road surface markings.

6. The method of claim 1, wherein in step a), the images captured by the image capturing unit do not contain the license plate of the vehicle when the vehicle is parked in the parking space.

7. A method for billing of a parking fee, the method to be implemented by a system which includes an image capturing unit capturing continuously a sequence of images of a parking space, a storage unit storing data associated with use of the parking space, and a processing unit electrically connected to the image capturing unit and the storage unit, the method comprising the steps of:
A) determining whether any license plate identifier data and time data is stored in the storage unit after obtaining a current image of the images captured by the image capturing unit, the images containing a license plate of a vehicle only as the vehicle is entering or leaving the parking space;
B) when it is determined in step A) that neither license plate identifier data nor time data is stored in the storage unit, determining whether a target associated with the parking space is contained in the current image, and determining whether a license plate identifier of the vehicle is recognized in the current image after performing image recognition on the current image;
C) storing time at which the current image is captured and the license plate identifier in the storage unit to respectively serve as the time data and the license plate identifier data when it is determined in step B) that no target is contained in the current image and that the license plate identifier is recognized in the current image;
D) determining whether the target associated with the parking space is contained in the current image when it is determined in step A) that the license plate identifier data and the time data are stored in the storage unit; and
E) calculating a parking fee of the vehicle according to a parking rate, the time data, and the time at which the current image is captured when it is determined in step D) that the target associated with the parking space is contained in the current image.

8. The method of claim 7, further comprising, subsequent to step B), the step of:
F) generating an output of error indication when it is determined in step B) that no target associated with the parking space is contained in the current image, and that no license plate identifier of the vehicle is recognized in the current image.

9. The method of claim 7, further comprising, subsequent to step E), the step of:
G) clearing the license plate identifier data and the time data stored in the storage unit.

10. The method of claim 7,
wherein step C) includes further storing in the storage unit the current image, and at least one previous image of the images captured by the image capturing unit within a predetermined time period before the current image is captured;
wherein step E) includes further storing in the storage unit the current image, and at least one previous image of the images captured by the image capturing unit within a predetermined time period before the current image is captured.

11. The method of claim 7, the parking space being marked by road surface markings, wherein in step B), the target associated with the parking space is a predetermined portion of the road surface markings.

12. The method of claim 7, wherein in step A), the images captured by the image capturing unit do not contain the license plate of the vehicle when the vehicle is parked in the parking space.
